(19) United States
(12) Patent Application Publication
(10) Pub. No.: US 2004/0034598 A1
(43) Pub. Date: Feb. 19, 2004

(54) System and method for biological authorization for financial transactions

(76) Inventor: Timothy Robinson, Herndon, VA (US)

Correspondence Address: Roberts Abokhair & Mardula, LLC, Suite 1000, 11800 Sunrise Valley Drive, Reston, VA, 20191, US

(21) Appl. No.: 09/765,789

(22) Filed: Jan. 19, 2001

Related U.S. Application Data
(60) Provisional application No. 60/177,235, filed on Jan. 20, 2000.

(51) Int. Cl. G06F 17/60

(52) U.S. Cl. 705/44

(57) ABSTRACT

A system and method for selectively authorizing user-specified amounts of money for access by third parties using biological or physiological authentication. A secure infrastructure is provided via which primary account holders are free to control access by third parties to their accounts with a great deal of flexibility. The authorized third parties verify their identity at the point of purchase via a biological identification device, such as a fingerprint reader, associated with a payment terminal.

### CROSS REFERENCE TO RELATED APPLICATIONS

This application claims priority under 35 U.S.C. § 119(e) from provisional application No. 60/177,235, filed Jan. 20, 2000. The 60/177,235 provisional application is incorporated by reference herein, in its entirety, for all purposes.

### INTRODUCTION

This application relates generally to the authorization of funds electronically. More particularly, the present invention provides a system and method for selectively authorizing user-specified amounts of money for access by third parties using biological or physiological authentication.

### BACKGROUND OF THE INVENTION

It is frequently the case that funds may be required by dependents of a primary cardholder for legitimate purposes. For example, a child away at college may require access to funds from time to time. However the primary cardholder, for example the parent, may not wish to have the child have access to unlimited amounts of funds for fear that the privilege may be abused.

Another situation where finds may be required relates to domestic and foreign travel. When an individual is on foreign travel, in order to minimize the potential for fraud, specific limits may be desired to be placed upon automated teller machine withdrawals from credit cards and other financial devices.

What would be quite useful is to allow third parties to have access to funds subject to particular limits that can be flexibly set by a primary card or account holder. It would be further useful if the primary card or account holder can create such limitations and authorizations over a network such as the word wide web.

### SUMMARY OF THE INVENTION

It is therefore, an objective of the present invention to allow third parties to have access to funds of a primary card/account holder (hereinafter the primary account holder).

It is a further objective to allow the primary account holder to flexibly set limitations on the access of funds by third parties.

It is yet another objective of the present invention to allow the primary account holder to specify limitations based upon dollar amounts in a particular period of time.

It is yet another objective of the present invention to set geographic limits associated with the travel of third parties who might potentially access the finances of the primary account holder.

It is yet another objective of the present invention to allow the primary account holder to flexibly set limitations on access to the primary account by third parties over a network such as for example, the world wide web.

It is yet another objective of the present invention to allow the primary account holder to specify limitations based upon type of merchant (Standard Industry Codes).

It is yet another objective of the present invention to allow the primary account holder to specify limitations based upon type of transaction (i.e. cash advance or purchase).

It is yet another objective of the present invention to allow authorization for access to funds in the primary account by biological and physiological authentication.

The present invention provides a secure infrastructure via which primary account holders are free to control access by third parties to their accounts with a great deal of flexibility.

The present invention is a system and method for the authorization of access by a third party to a value account controlled by a primary account holder using biological or physiological authentication. For purposes of this application, a primary account holder is the person financially responsible for the use of a particular value account.

The term “value account” is meant by applicant to refer generically both to credit accounts, funds accounts, or other accounts representing things or intangibles of value. Common examples of value accounts are a bank account, a credit instrument, or a line of credit with a merchant for which the primary account holder is responsible. To the extent that the primary account holder desires to authorize other persons to have access to such accounts, the present invention is useful.

As an example, the present invention is embodied as one or more accounts, or lines of credit, which are held in one or more banks or other credit facilities (e.g., VISA, MasterCard, American Express). A primary account holder is named as the responsible party for both depositing funds and for payment of bills incurred by the value account. The value account, residing in some form of financial institution, is electronically connected to a network. The network may be private or may be an open, globally-interconnected network of networks, such as the Internet.

According to the preferred embodiment, the primary account holder is also connected to the same network via a communication device, such as home computer, a cellular telephone, a wireless personal digital assistant, a two-way pager, or other similar devices known in the art.

### BRIEF DESCRIPTION OF THE DRAWINGS

Additional objects and advantages of the present invention will be apparent in the following detailed description read in conjunction with the accompanying drawing figures.

FIG. 1 illustrates the architecture of a system according to an embodiment of the present invention.

FIG. 2 illustrates a flow chart diagram of the initial registration process by the primary account holder.

FIG. 3 illustrates a flow chart diagram of the process of initial authorization of third parties to the value account.

FIG. 4 illustrates a flow chart diagram of access to the primary account by an authorized third party.

### DETAILED DESCRIPTION OF THE INVENTION

As noted earlier, the present invention is a system and method for allowing a primary account holder to authorize third parties to access a value account subject to flexible limitations set by the primary account holder.

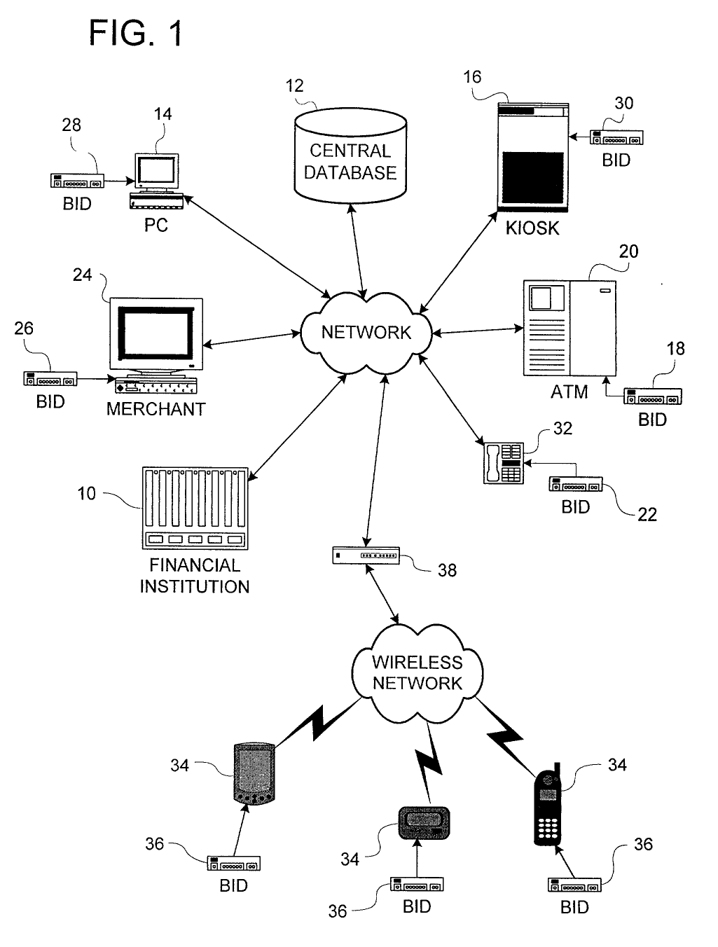

Referring to FIG. 1, the architecture of the present invention is illustrated. The primary account holder registers for services according to the present invention at a registration kiosk 16. The primary account holder allows authorization by password for Internet access to accounts. The primary account holder has access to a workstation or personal computer 14 that is connected via a network (preferably, but without limitation, including the Internet) to the central database 12.

Optionally, a biological identification device (BID) 28 is connected to the primary account holder's personal computer 14. This biological identification device is preferably a fingerprint reader, and is alternatively embodied as a voiceprint reader, an iris recognition device, or a retinal recognition device. The BID may be embodied as any suitable biological identification device. For purposes of example only and without limitation, this BID will be discussed as a fingerprint identification device.

Also connected to the central database 12 via the network is a bank or financial institution 10 in which the primary account holder has his bank account.

The primary account holder can access and transfer funds in the value account at a financial institution 10 via a number of ways. One way for the primary account holder to gain access is via the PC 14 in conjunction with either the BID 28, or the appropriate password. A second way is for the primary account holder to gain access via the kiosk 16 in conjunction with the BID 30. A third way for the primary account holder to gain access is via the telephone 32 (or a wireless device) in conjunction with either the appropriate password, or the BID 22.

The primary account holder can also use the PC 14, kiosk 16, telephone 32, or a wireless device 34 to identify a third party (a spouse, a child, an employee, etc.) by their system ID number as being one who is allowed to have access to the value account. The third party shall have registered at a kiosk 16 (or otherwise) to obtain a system ID number. The third party's biological identity indication is represented by their system ID number, which is preferably stored in the central database 12. The third party performs a transaction at a merchant 24, accessing the value account at the financial institution 10, by reading the biological indicator on the merchant 24 BID 26.

The primary account holder has the option according to the present invention of flexibly designating a variety of parameters associated with access by the third party to the value account at the financial institution 10. For example, the basic limitation is the identification by a BID that the person attempting to gain access is the one that is authorized to access the account. This is preferably enhanced by a specific system ID number for the individual.

In addition to the basic authentication and limitation of the specific biological indicator, the primary account holder has the option of limiting:

the amount that can be withdrawn at any particular time by the third party,

a total amount that can be withdrawn during any particular period of time,

the geographic locale from which funds may be requested,

a range of dates over which funds can be requested by the third party,

specific merchant types where transactions may or may not be requested, and

other factors over which a primary account holder chooses to exert control.

For example, such controls enable a parent to limit the amount of money that a child attending college could obtain on a monthly basis. Extending the example, parental controls would further limit the location from which such funds could be withdrawn. If the child is supposed to be in one state, but attempts to withdraw funds from the value account when the child is located in another state, such access is denied.

In addition to limiting third parties, the primary account holder is empowered to limit his or her own access to the account to allow funds to be withdrawn to prevent fraud from occurring. For example, if the primary account holder is on travel in a foreign country, the primary account holder elects to allow funds to be deducted from the value account for a period of time when the person is on travel in a particular country. Accordingly, if a physical access device for the value account (check, debit card, credit card, check etc.) is lost or stolen, and then used in another country, that use could be denied based upon the geographic limitations placed on the account by the primary account holder and further denied by virtue of the fact that the biological indicator would not allow the unauthorized third party to access the funds in the first instance.

As part of the present invention, it is anticipated that a BID 18, associated with an ATM 20 (or other locations where funds are dispersed), is also connected via the network to the central database 12.

It is expected that that wireless communication of biological information will also be used with the present invention. A new generation of wireless communication devices 34 having fingerprint identification exists so that wireless communication fraud can be avoided. These wireless communication devices 34 communicate via their native wireless network and access a broader network on which the central server resides via a WAP interface 38 or other appropriate network connection. Alternatively, a wireless central server is implemented directly on the wireless network as a supplemental mirror facility to the central database. The wireless central server is programmed (for example, using WML or other wireless oriented language) for optimum interface with wireless communication devices 34.

Using such a wireless communication device 34, the primary account holder has the power to authorize account parameter changes via an appropriate password or via a BID 36. This enables the primary account holder to flexibly allow (or disallow) access to funds in the value account at the financial institution 10 by sending messages over a network to the central database 12.

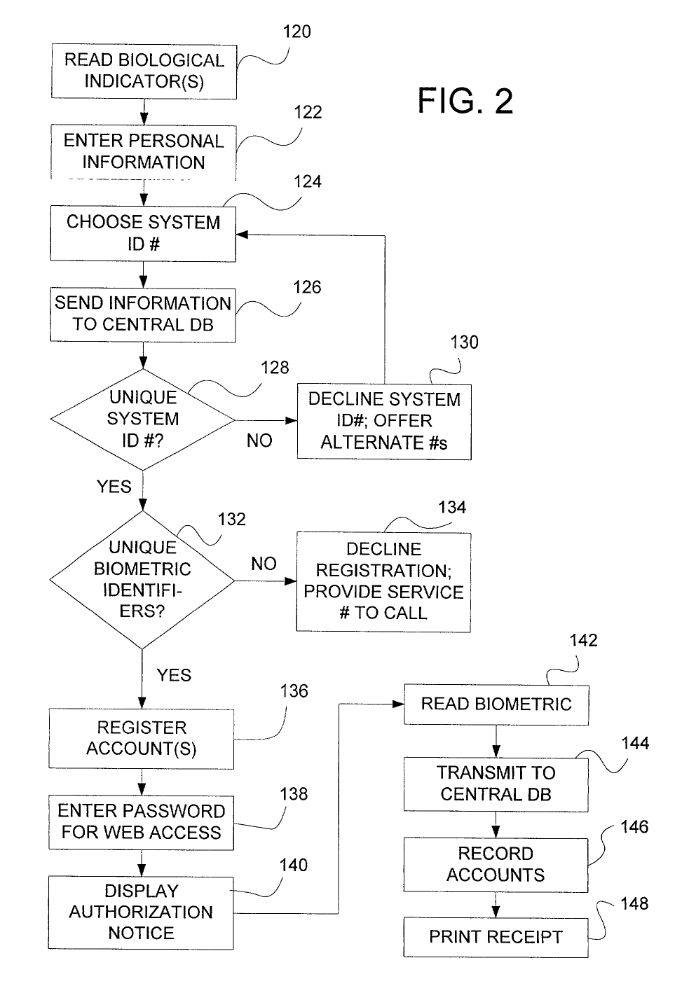

Referring to FIG. 2, the general flow of the initial registration process is illustrated. The primary account holder begins registration at a kiosk, customer service desk, or checkout lane with a BID and enters his biological indicator or indicators 120. He is prompted to enter personal information 122, which may simply be driver's license data read from a magnetic stripe, or include social security number, address, phone number, or any other information about the primary account holder. Then the primary account holder is asked to choose a system identification number 124. This number may be a social security number, phone number, phone number plus one or two digits, or any other reasonably unique number easily remembered by the account holder. After the number is chosen, all data entered is transmitted to the central database 126 via a network such as the Internet.

The central database determines if the system identification number is unique 128. If not, the primary account holder is prompted to choose a different number, and is offered suggestions, such as adding a digit to the previously chosen number 130. However, absolute uniqueness of the system identification number is not strictly required to practice the invention. It is contemplated that the invention be practiced such that the system identification number need only be reasonably unique. A reasonably unique identifying number is one that has a statistically small chance of being duplicated. A reasonably unique identifying number may also be one that is intentionally common to a small, select group of individuals, say members of a family, or partners in a business.

At this point, the personal information and biological identifiers will be compared to the central database for uniqueness 132. If certain information, such as name, social security number, or biological identifiers have been previously registered the registration will be declined 134 with the reason stated with notification of how to contact central database management personnel. This contact may be immediately available at the kiosk.

If all information is unique, the primary account holder is prompted to enter their account information 136. Checking account information is entered by a MICR read, an optical read, hand keying, or other method of input. Credit card or debit card information is entered by a magnetic stripe read, hand keying, or another method of input.

At this point, the primary account holder is prompted to enter a password, which will provide him with access to his accounts via the Internet 138. The terminal will present a notice to the primary account holder providing authorization to access the registered accounts via the biological identicators of the primary account holder 140. For example, the notice may state:

“I authorize the central database authority to electronically access my accounts upon presentation of my biological identicators, or presentation of my selected password over the Internet, or via a wireless communication device.”

The primary account holder will be prompted to enter his biological identicators 142, to authorize future transactions. The biological indicators and account information will be transmitted to the central database 144 and recorded in the database 146. The terminal prints a receipt (at the primary account holder's option) giving tangible written notice of the primary account holder's authorization to access his accounts 148.

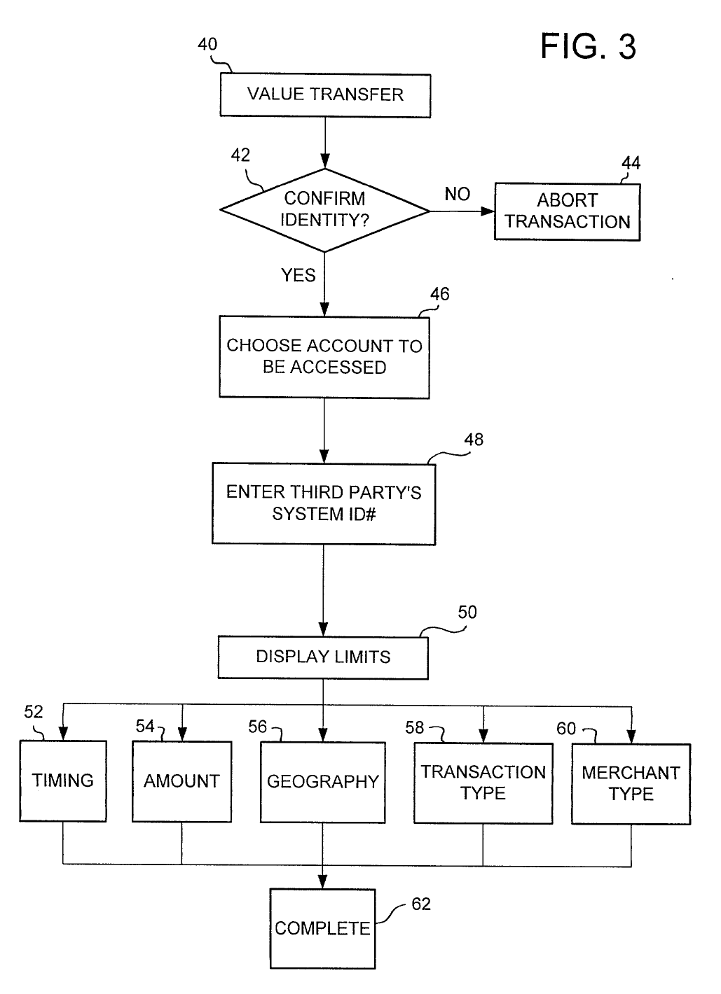

Referring to FIG. 3, the general flow chart of the initial authorization process is illustrated. A primary account holder accesses the central database via PC 14 or kiosk 16, chooses Value Transfer 40, and provides identification, whether biological or otherwise 42. If the identification is not confirmed, the transaction is cancelled 44.

If the correct identification is provided, the primary account holder notes that he wishes to authorize third party access to one of the accounts 46. At that point the primary account holder enters the third party's system identification number 48. The primary account holder then is offered the option of setting certain limits 50 on access to the account.

The primary account holder is prompted to select each of the various options such as time limitations 52. Time limitations specify whether the funds (or credit) will be available one time only, recurring (i.e., “use or lose”) for a time period, recurring indefinitely, or are to accrue. Amount limitations 54 on transactions specify a predetermined threshold amount that may not be exceeded in a single transaction or an aggregation of transactions. Geography limitations 56 specify what city, state, or country transactions will be available in. Limitations as to the type of transactions 58 specify whether cash advances or merchandise only will be available. Merchant type limitations 60 might specify which Standard Industry Class (SIC) codes will be available. Once the appropriate limitations on access to funds have been specified, the transaction is completed 62. The limitation modes listed are examples, and are not meant to limit the scope of the invention, since other limitation modes are possible.

It is possible for the primary account holder to allow access to multiple accounts, whereby the primary account holder sets parameters to determine which account will be accessed.

Optionally, the primary account holder is presented with the options of setting an order of accounts to be accessed whereby if a first account is overdrawn, then the transaction will access a subsequent account.

Another optional mode of operation is for the account access parameters be set up for a plurality of third parties according to a hierarchical rule system. An example of a situation where hierarchical authorization is useful is in the context of a school. The school system superintendent is authorized to spend amount X, each of the principals in the school system is authorized to spend amount X′ (which is naturally smaller than amount X authorized for the superintendent), and each teacher in the school system is authorized to spend amount X″ (which is naturally smaller than amount X′ authorized for the principals).

Referring to FIG. 4, access to the primary account by an authorized third party is illustrated. The third party begins a transaction 70 and the transaction amount is entered 72. This amount may be entered by the third party for example at an ATM, or by a merchant for example at a retail store. The third party then inputs their system identification number 74, followed by a biological identifier 76, such as a fingerprint. The third party then picks from a menu the account to access 78. The account menu may, for example, list Account #1, Account #2, etc. or Checking Account #1, Credit Card #1, Credit Card #2, etc.

The amount, fingerprint, and system identification number are then transmitted to the central database 80. The combination of the biological identifier and the system identification number uniquely identifies the third party 82. If the person is not identified, the transaction is declined 84. If the identity is confirmed, the third party's authorization to access the account is processed 86. If the third party is not authorized to access the account chosen, the transaction is declined 88. If the individual is authorized, the authorization parameters are compared 90. If the transaction meets the authorization parameters the transaction is approved 94, and a receipt is printed by the terminal 96. If however, any parameter is exceeded, the transaction is declined and the process ends 92.

As noted above, this process is preferably also used to limit account access by the primary account holder himself during the course of foreign or domestic travel, in order to limit the potential for fraud.

As described above, the central database functions both as a storehouse for biological identification information, and as an authorization authority that makes the automated decision (based on the primary account holder's previously recorded instructions) on transaction authorization. However, both functions need not be centralized. Instead one or both of these functionalities is optionally distributed among other devices in a network.

According to a hybrid embodiment, the central database continues to function as a storehouse for biological identification information. However, this central facility does not conduct transaction authorization processing. The authorization processing is handled locally at or near the location of the transaction so that the authorization processing burden is distributed around the network. When the third party initiates the transaction, providing their system identification number and their fingerprint, only the system identification number is transmitted across the network to the central database, which returns to the local server the appropriate biological identification data for comparison to the fingerprint the third party has just provided. That local server actually makes the comparison and applies the conditions previously set by the primary account holder under which the value account may be accessed. Thus authorization is distributed while ID data is stored centrally.

It is also an alternate embodiment of the present invention for both authorization processing and biological ID information storage to be distributed. Operationally, this embodiment is very similar to the one previously described where authorization is distributed and ID data is stored centrally. One difference is that in the event the merchant server has the third party's biological ID information stored locally, then the merchant server proceeds directly to performing authorization processing. The only transmission to the central database server is to indicate occurrence and disposition (approved/denied) of the transaction. This data is then used for notification of the primary account holder. However, in the event that the merchant server does not have the third party's biological ID information stored locally, the merchant server then sends out a request for the information to the central database. The central database then broadcasts this request for the relevant data across the network to other facilities that store such data. The appropriate storage device responds by returning to the central database the appropriate biological identification data for relay to the merchant server or, in the alternative, transmits it directly to the merchant server. Once the biological ID information is obtained, the merchant server makes a comparison to the fingerprint the third party has just provided. Thus, both authorization processing and storage of ID information are distributed.

According to another hybrid embodiment, the central database stores no biological identification information but conducts all authorization processing for the system. The storage of biological identification information is handled locally at or near the location of the transaction so that the data storage burden is distributed around the network. When the third party initiates the transaction, providing their system identification number and their fingerprint, the merchant server transmits a package of information across the network to the central database. The package of information contains the system identification number provided, an extract of biological ID data from the fingerprint proffered, and (if available in the merchant server's own database) the biological identification data corresponding to the that third party, as previously recorded. In the event that the merchant server local to where the transaction is being initiated does not have a copy of that third party's biological identification data, then the central database sends out a request for the relevant data across the network to other facilities that store such data. The appropriate storage device responds by returning to the central database the appropriate biological identification data for comparison to the fingerprint the third party has just provided. That central database actually makes the comparison and applies the conditions previously set by the primary account holder under which the value account may be accessed. Thus authorization is done centrally while ID data is distributed.

An additional feature of the present invention is wireless notification of the primary account holder that an authorized third party has accessed an account. The wireless message (sent, for example, to a cell phone, PDA, or pager) is preferably an alphanumeric message that indicates at least the name of the party who accessed the account, and the amount of the transaction. This provides a near real time notification to the primary account holder of activity on the account.

Such notification is optionally made via an email message addressed to the primary account holder. Although email is not always as immediately accessible as a pager carried on one's person, the medium of email easily permits the message to include a detailed accounting of all relevant facts about the transaction, including (if desired) a listing of items bought from a merchant.

Another aspect of the present invention is real time authorization by the primary account holder of transactions involving the value account. This means that the transaction completion is contingent upon real time assent by the primary account holder, rather than a rule-based, automated approval/disapproval as described above. At the primary account holder's option, certain transactions are designated as requiring a real time confirmation by the primary account holder. For example, transactions that exceed a predetermined threshold amount (e.g., $500.00), or purchases of certain predetermined types of goods (e.g., casino chips or liquor), or transactions outside a pre-approved geographic area (e.g., across the state line).

The real time authorization aspect of the present invention is implemented through any of a number of high tech or low tech options. One method is to request approval of the transaction from the primary account holder by sending a message to his or her wireless communication device with integrated BID. Another method is to request approval of the transaction via telephone (wireless or POTS) and then simply authenticate any approval by querying the putative primary account holder for the password.

A biological identification authorization system for financial transactions has been illustrated. It will be appreciated by those skilled in the art that the system and methods of the present invention can be used to authorized and prevent fraud in such areas as telecommunications services, access to bank accounts, and financial and information transactions of many different kinds. Thus, the present invention is not limited in its utility only to access to value accounts. Specifically, the present invention has utility in preventing unauthorized access to information stored on various types of information servers.

The present invention has been described in terms of preferred embodiments, however, it will be appreciated that various modifications and improvements may be made to the described embodiments without departing from the scope of the invention.

What is claimed is:

1. A method for providing approval for a third party to access a value account controlled by a primary account holder, the process comprising:
receiving a biological sample proffered by the third party via a biological identification device;
comparing the proffered biological sample to biological identification data stored in a database;
making a determination of whether the third party has been authorized by the primary account holder to access the value account; and
in the event that the third party is determined to be authorized to access the account, transmitting an approval signal indicating that the third party may have access to the value account.

2. The method for providing approval as claimed in claim 1, the method further comprising:
receiving an identification code proffered by the third party,
wherein making the determination is performed based on both the identification code and comparing the proffered biological sample.

3. The method for providing approval as claimed in claim 2, wherein the identification code corresponds to a credit card number.

4. The method for providing approval as claimed in claim 2, wherein the identification code corresponds to a signal from an RF transponder device.

5. The method for providing approval as claimed in claim 2, wherein the identification code corresponds to a magnetic ink character recognition code read from a negotiable instrument.

6. The method for providing approval as claimed in claim 2, wherein the identification code corresponds to a public encryption key.

7. The method for providing approval as claimed in claim 2, wherein the identification code corresponds to a DL swipe.

8. The method for providing approval as claimed in claim 2, wherein the identification code corresponds to a wireless device selected from the group consisting of: a bluetooth-enabled telephone, a bluetooth-enabled personal digital assistant, an infrared-enabled phone, and an infrared-enabled personal digital assistant.

9. The method for providing approval as claimed in claim 2, wherein the identification code is absolutely unique.

10. The method for providing approval as claimed in claim 2, wherein the identification code is reasonably unique.

11. The method for providing approval as claimed in claim 1, wherein the biological sample corresponds to a fingerprint of the third party.

12. The method for providing approval as claimed in claim 1, wherein the biological sample corresponds to an iris scan of the third party.

13. The method for providing approval as claimed in claim 1, wherein the biological sample corresponds to a facial scan of the third party.

14. The method for providing approval as claimed in claim 1, wherein the biological sample corresponds to a voice scan of the third party.

15. The method for providing approval as claimed in claim 1, further comprising:
in the event that the approval signal is transmitted, transmitting a notification signal to the primary account holder indicating that the third party has accessed the value account.

16. The method for providing approval as claimed in claim 15, wherein the notification signal is transmitted to a wireless device.

17. The method for providing approval as claimed in claim 15, wherein the notification signal is transmitted as an email message.

18. A method for providing approval for a third party to access a value account controlled by a primary account holder, the process comprising:
receiving a biological sample proffered by the third party via a biological identification device;
comparing the proffered biological sample to biological identification data stored in a database;
making a first determination, based on comparing the proffered biological sample, of whether the third party is registered in the database;
in the event that the third party is determined to be registered in the database, making a second determination of whether the third party has been authorized by the primary account holder to access the value account; and
in the event that the third party is determined to be authorized to access the value account, transmitting an approval signal indicating that the third party may have access to the account.

19. The method for providing approval as claimed in claim 18, the method further comprising:
receiving an identification code proffered by the third party,
wherein making the first determination is performed based on both the identification code and comparing the proffered biological sample.

20. The method for providing approval as claimed in claim 19, wherein the identification code corresponds to a credit card number.

21. The method for providing approval as claimed in claim 19, wherein the identification code corresponds to a signal from an RF transponder device.

22. The method for providing approval as claimed in claim 19, wherein the identification code corresponds to a magnetic ink character recognition code read from a negotiable instrument.

23. The method for providing approval as claimed in claim 19, wherein the identification code corresponds to a public encryption key.

24. The method for providing approval as claimed in claim 19, wherein the identification code corresponds to a DL swipe.

25. The method for providing approval as claimed in claim 19, wherein the identification code corresponds to a wireless device selected from the group consisting of: a bluetooth-enabled telephone, a bluetooth-enabled personal digital assistant, an infrared-enabled phone, and an infrared-enabled personal digital assistant.

26. The method for providing approval as claimed in claim 18, wherein the biological sample corresponds to a fingerprint of the third party.

27. The method for providing approval as claimed in claim 18, wherein the biological sample corresponds to an iris scan of the third party.

28. The method for providing approval as claimed in claim 18, wherein the biological sample corresponds to a facial scan of the third party.

29. The method for providing approval as claimed in claim 18, wherein the biological sample corresponds to a voice scan of the third party.

30. A method for providing approval for a third party to access a value account controlled by a primary account holder, the process comprising:
receiving a biological sample proffered by the third party via a biological identification device;
receiving transaction data corresponding to a transaction on the value account, initiated by the third party;
comparing the proffered biological sample to biological identification data stored in a database;
making a first determination, based on comparing the proffered biological sample, of whether the third party is registered in the database;
in the event that the third party is determined to be registered in the database, making a second determination of whether the third party has been authorized by the primary account holder to access the account; and
in the event that the third party is determined to be authorized to access the account, making a third determination of whether the transaction data goes beyond a predetermined transaction parameter limit; and
in the event that the third party is determined to be authorized to access the account, and it is determined that the transaction data does not go beyond the predetermined transaction parameter limit, transmitting an approval signal indicating that the third party may have access to the account.

31. The method for providing approval claimed in claim 30, wherein the predetermined transaction parameter limit has been set by the primary account holder.

32. The method for providing approval claimed in claim 30, wherein the transaction data comprises the value of the transaction.

33. The method for providing approval claimed in claim 30, wherein the transaction data comprises the geographical location of where the transaction is initiated.

34. The method for providing approval claimed in claim 30, wherein the transaction data comprises the geographical location of where the transaction is fulfilled.

35. The method for providing approval claimed in claim 30, wherein the transaction data comprises whether the transaction is a cash advance.

36. The method for providing approval claimed in claim 30, wherein the transaction data corresponds to whether the transaction is a purchase of merchandise.

37. The method for providing approval claimed in claim 30, wherein the transaction data comprises the type of merchant conducting the transaction.

38. The method for providing approval claimed in claim 30, wherein the transaction data comprises the type of merchandise being purchased in the transaction.

39. The method for providing approval claimed in claim 30, wherein the predetermined transaction parameter places a limit on the number and amount of transactions occurring over a predetermined period of time.

40. A method for providing approval for a third party to access an account controlled by a primary account holder, the process comprising:
receiving a biological sample proffered by the third party via a biological identification device;
comparing the proffered biological sample to biological identification data stored in a database;
making a first determination, based on comparing the proffered biological sample, of whether the third party is registered in the database;
transmitting a signal to an empowered party indicating that the third party has initiated a transaction involving the account;
receiving a signal from the empowered party indicative of whether the transaction is approved; and
in the event that the signal received from the empowered party indicates that the transaction is approved, transmitting an approval signal indicating that the third party may have access to the account.

41. The method for providing approval as claimed in claim 40, wherein the empowered party is the primary account holder only.

42. The method for providing approval as claimed in claim 40, wherein the empowered party comprises an agent of the primary account holder.

43. A system for biological authorization of financial transactions, the system comprising:
a merchant terminal including a biological identification device;
a central database server connected by a first network path to the merchant terminal to receive a payment request accompanied by a biological ID signature generated by the biological identification device and a personal ID number presented by a purchaser; and
a financial institution server connected by a second network path to the central database server to receive the payment request accompanied by an authorization packet;
wherein, in the event that the financial institution server receives the payment request accompanied by the authorization packet, and the value account corresponding to the payment request has sufficient available value, then a transaction authorization is transmitted to the merchant terminal.

44. The system for biological authorization of financial transactions as claimed in claim 43, wherein the biological identification device is a finger print reader.

45. The system for biological authorization of financial transactions as claimed in claim 43, wherein the authorization packet is generated at the central database server based at least on a comparison of the biological ID signature generated by the biological identification device with previously obtained biological ID information corresponding to the purchaser.

46. The system for biological authorization of financial transactions as claimed in claim 45, wherein the previously obtained biological ID information is stored at the central database server.

47. The system for biological authorization of financial transactions as claimed in claim 43, wherein the transaction authorization is transmitted directly from the financial institution server to the merchant terminal via a third network path

48. The system for biological authorization of financial transactions as claimed in claim 43, wherein the transaction authorization is transmitted indirectly from the financial institution server to the merchant terminal via the central database server.

49. A method for a primary account holder to establish authorization for access to a value account, the method comprising:
receiving a biological sample proffered via a biological identification device;
comparing the proffered biological sample to biological identification data stored in a database;
making an identity determination, based on comparing the proffered biological sample, of whether the proffered biological sample is consistent with the identity of the primary account holder;
receiving a system identification number corresponding to an identified person who has previously registered their biological identification data in the database;
presenting options for transaction parameter limits for the identified person; and
receiving one or more selections of transaction parameter limits according to the options presented;
wherein, in the event that it is determined that the proffered biological sample is consistent with the identity of the primary account holder, the identified person is authorized to access the value account subject to the transaction parameter limits selected.

50. The method for a primary account holder to establish authorization for access to a value account, as claimed in claim 49, wherein the biological identification device via which the biological sample is proffered is connected to a kiosk.

51. The method for a primary account holder to establish authorization for access to a value account, as claimed in claim 49, wherein the proffered biological sample is received via the Internet.

52. The method for a primary account holder to establish authorization for access to a value account, as claimed in claim 49, wherein the biological identification device via which the biological sample is proffered is connected to a wireless communication device.

53. The method for a primary account holder to establish authorization for access to a value account, as claimed in claim 49, wherein the identified person is a third party.

54. The method for a primary account holder to establish authorization for access to a value account, as claimed in claim 53, wherein the third party's authorization is hierarchical with respect to other third party persons.

55. The method for a primary account holder to establish authorization for access to a value account, as claimed in claim 49, wherein the identified person is the primary account holder.

56. The method for a primary account holder to establish authorization for access to a value account, as claimed in claim 49, further comprising:
presenting options for contingency limitations on access to the value account;
receiving one or more selections of contingency limitations according to the options presented;
wherein the identified person's access to the value account is further subject to the contingency limitations selected.

57. The method for a primary account holder to establish authorization for access to a value account, as claimed in claim 56, wherein the identified person's access to the value account is subject to the condition that access is permitted only in the contingent event that another value account has become overdrawn.
